(19) United States
(12) Patent Application Publication
(10) Pub. No.: US 2012/0054608 A1
(43) Pub. Date: Mar. 1, 2012

(54) ELECTRONIC DEVICE CAPABLE OF GUIDING READING AND METHOD THEREOF

(75) Inventors: JI LI, Shenzhen City (CN); HUA-DONG CHENG, Shenzhen City (CN); CHIH-SAN CHIANG, Tu-Cheng (TW); HAN-CHE WANG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/044,556

(22) Filed: Mar. 10, 2011

(30) Foreign Application Priority Data
Aug. 25, 2010 (CN) 201010262467.5

(51) Int. Cl. G06F 3/01

(52) U.S. Cl. 715/709

(57) ABSTRACT

An electronic device includes a content display module, a storage, and a reading control module. A guidance list is stored in the storage, which defines a relationship between users and guidance behaviors relating to the users, the guidance behaviors includes guide speeds and word changes corresponding to the user. The reading control module includes a font changing sub-module and a page flipping control module. The font changing sub-module searches the guidance list to obtain the guide speed and the word changes corresponding to a particular user, and controls the fonts of the words on a current page of the file to change sequentially according to the guide speed and the word changes. The flipping control sub-module signals the content display module to flip to a next page when the current page is finished. A related method of guide reading is also provided.

### BACKGROUND

1. Technical Field

The present disclosure relates to an electronic device capable of guiding the reading, and a method employed by the device.

2. Description of the Related Art

Conventional electronic books (e-book) execute a function of flipping the pages, when users operate a touch panel or a mechanical button equipped in the e-book to command the e-book. Commonly, users' eyes may feel strained after going through a great number of pages and their arms and fingers may feel tired after repeatedly flipping the pages. It is inconvenient and uncomfortable for the users at that moment to operate the e-book to turn pages.

Therefore, there is room for improvement within the art.

### BRIEF DESCRIPTION OF THE DRAWINGS

The components in the drawings are not necessarily drawn to scale, the emphasis instead being placed upon clearly illustrating the principles of a method and an electronic device capable of guiding the reading. Moreover, in the drawings, like reference numerals designate corresponding parts throughout the several views.

FIG. 1 is a block diagram of an electronic device in accordance with an exemplary embodiment.

FIG. 2 is a use state diagram for setting guide speeds on the electronic device of FIG. 1.

FIG. 3 is a flowchart of a method for an electronic device guiding the reading in accordance with an exemplary embodiment.

FIGS. 4A-4C are exemplary general views showing fonts that are changed in sequence to guide users to read the contents on the electronic device of FIG. 1.

### DETAILED DESCRIPTION

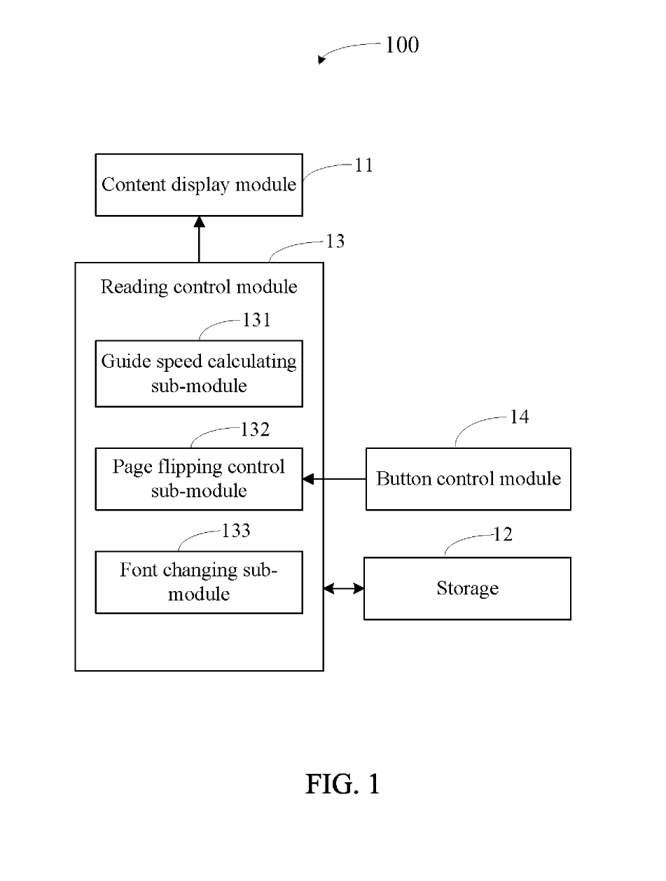

FIG. 1 is a block diagram of an electronic device. The electronic device 100 is capable of guiding users to read contents in the electronic device 100. The electronic device 100 includes a content display module 11, storage 12 and a reading control module 13. The electronic device 100 may also provide buttons for users to enable and disable the guide function of the electronic device 100. In the embodiment, the electronic device 100 may provide a user interface to preset the guidance behavior of the guide functions. The guidance behavior includes but is not limited to guide speeds and word changes.

The content display module 11 is configured to display contents of a file on an interface of the electronic device 100 when the text reading function is enabled. The storage 12 stores a guidance list. The guidance list defines a congruent relationship between users and guidance behavior relating to the users. In the embodiment, the users are represented by their user names. The guidance behavior includes guide speeds and word changes associate with the user names defined by the users corresponding to the user names. In the exemplary embodiment, the word changes include changes in font size, which means the words of the displayed contents have different font size in sequence to the guide speed. Generally, for consideration and convenience of the users, the words are enlarged in sequence to the guide speed. In another exemplary embodiment, the font changes may further include changes in font color and/or font style. The words, font color and/or font style are changed in sequence to the guide speed,

If shared by more than one users, in the exemplary embodiment, the electronic device 100 may provide a guiding interface for new users to register and for registered users to login in and start the guide function. In an exemplary embodiment, the guiding interface is presented in accompany with the completion of the powering on process of the electronic device 100. In an alternative embodiment, the guiding interface is presented when users operate a particular button provided for starting the guide function.

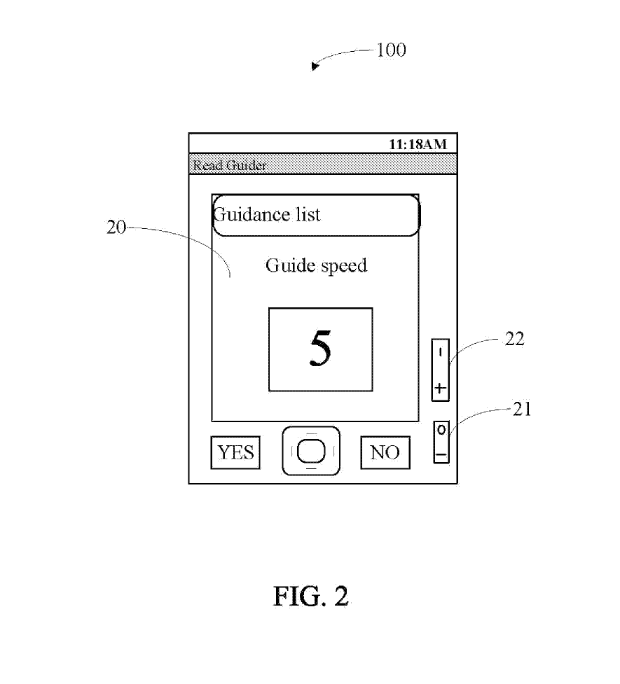

Referring to FIG. 2, the electronic device 100 may further provide an operating interface for users to preset or change the guidance behavior such as the guide speeds and/or the font changes associate with their names. For example, upon receiving a command for presetting or changing the guidance behavior from a particular button 21 on the electronic device 100, the electronic device 100 provides the operating interface 20 for users to preset the change of guidance behavior associate with their names. With the interface 20, users are able to preset or change the guide speeds and the word changes with a button 22, such as preset or increase/decrease the font size and the guide speed, preset or change the font color, and change the user names. Upon receiving a command for saving the changes from a particular button on the electronic device 100, the changes are saved to the guidance list.

The reading control module 13 is configured to search the guidance list to obtain the guide speeds and the font changes associate with the user names, and to control the change of the fonts of the words displayed on the interface according to the word changes in the guide speed obtained.

The reading control module 13 includes a guide speed calculating sub-module 130, a font changing sub-module 131, and a page flipping control sub-module 132. The guide speed calculating sub-module 130 is configured to calculate the guide speed, according to an elapsed time between two page flipping operations, and a volume of words displayed during the elapsed time. The guide speed calculating sub-module 130 can be enabled or disabled by users who operate a particular button on the electronic device 100. For example, when the user enables guide speed calculating sub-module 130 with a mechanical button on the electronic device 100, the guide speed calculating sub-module 130 monitors the operations the users apply to a “Page Down” button. In addition, determines the elapsed time between two adjacent operations on the “Page Down” button, and calculates the volume of words displayed during the elapsed time. Then, the volume of words is divided by the elapsed time value to get the guide speed, the guide speed is recorded in the guidance list associating with the corresponding user names.

The font changing sub-module 131 is configured to change the font of the words in sequence to the guide speed obtained in the guidance list.

The page flipping control sub-module 132 is configured to generate a signal of the page being flipped when the current page is finished, then the content display module 11 controls the display to display the contents of a next page.

The electronic device 100 further includes a button control module 14, configured to respond to the user's operations on buttons equipped on the electronic device 100.

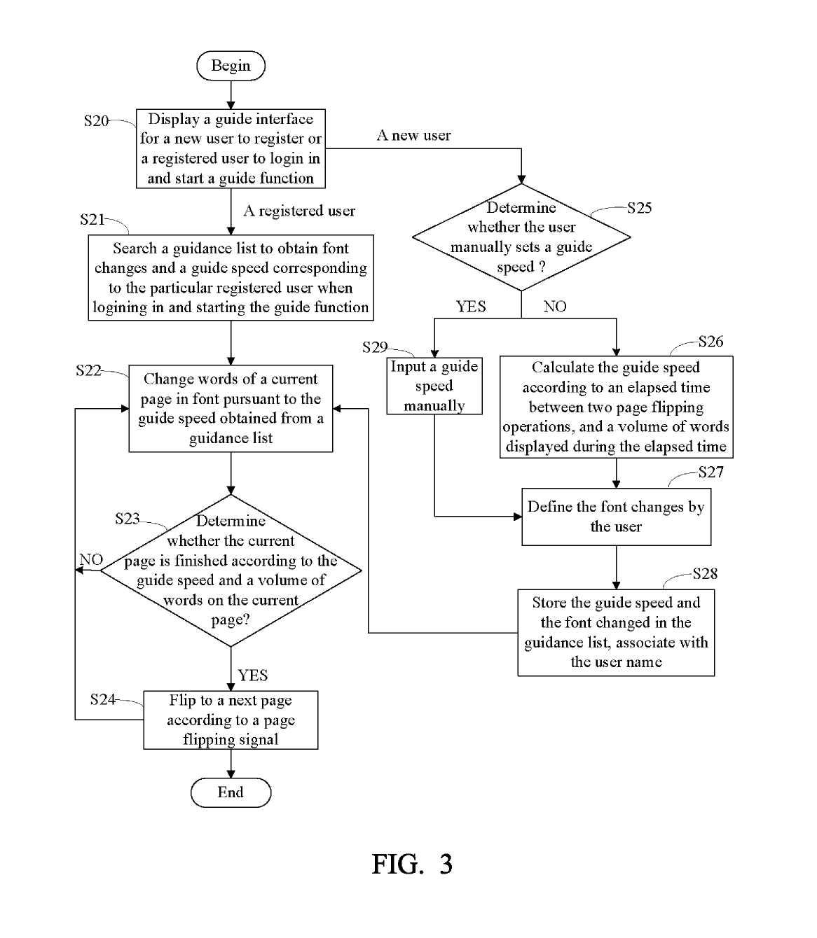

FIG. 3 is a flowchart of a method for an electronic device capable of guiding the reader.

In step S20, the reading control module 13 displays a guide interface for new users to register and for registered users to login in and start the guide function. In the exemplary embodiment, the guiding interface is presented in accompany with the completion of the powering on process of the electronic device 100. In an alternative embodiment, the guiding interface is presented when users operate a particular button provided for starting the guide function. For a registered user to login in and start the guide function, the procedure goes to step S21. For new users to register, the procedure goes to step S25.

The guidance behavior of users is stored in a guidance list. The guidance list is stored in the storage 12 and defines a congruent relationship between users and guidance behavior related to the users. In the embodiment, the users are represented by their user name, the guidance behavior includes the guide speeds and word changes associate with the user names and defined by the users corresponding to the user names.

In step S21, the reading control module 13 obtains the font change and the guide speed associate with the user name by searching the guidance list.

In step S22, the font changing sub-module 131 changes in the font in sequence to the guide speed which is obtained from the guidance list.

In step S23, the reading control module 13 determines whether the current page is finished according to the guide speed obtained and the volume of words on the current page. If the current page is finished, the procedure goes to step S24; otherwise, the procedure goes to step S22.

In step S24, the content display module 11 controls the display to display a next page according to the page flipping signal generated with the page flipping control sub-module 132.

Steps S22˜S24 repeats until the guide function is terminated.

In step S25, the reading control module 13 determines whether the user sets a guide speed in manual operation according to a selection signal generated by the button control module 14. If no, the procedure goes to step S26; otherwise, the procedure goes to step S29.

The electronic device 100 may further provide the operating interface for users to preset or change the guidance behavior such as the guide speeds and/or font changes associate with their names. For example, upon receiving a command for presetting or changing the guidance behavior from a particular button on the electronic device 100, the electronic device 100 provides the operating interface for users to preset or change the guide speed associate with their names. With the interface, users are able to preset a change in the guide speeds and the font changes, such as preset an increase or decrease the guide speed and the font size, change the font color, and change the user names.

In step S26, the guide speed calculating sub-module 130 calculates the guide speed, according to an elapsed time between two page flipping operations, and a volume of words displayed during the elapsed time.

The guide speed calculating sub-module 130 can be enabled or disabled by users who operate a particular button on the electronic device 100. For example, the user can enable the guide speed calculating sub-module 130 with a mechanical button on the electronic device 100. The guide speed calculating sub-module 130 monitors the operations the users apply to a “Page Down” button, determines the elapsed time between two adjacent operations on the “Page Down” button, and calculates the volume of words displayed during the elapsed time. Then, the volume of words is divided by the elapsed time value to get the guide speed, and the guide speed is recorded in the guidance list associating with the corresponding user names.

In step S27, the font changes are defined by the user.

In step S28, the guide speed and the font changes are stored in the guidance list, associating with the user name upon receiving a command for saving the changes from a particular button on the electronic device 100, and, then the procedure goes to step S22.

In step S29, the user manually inputs a guide speed, then the procedure goes to step S27.

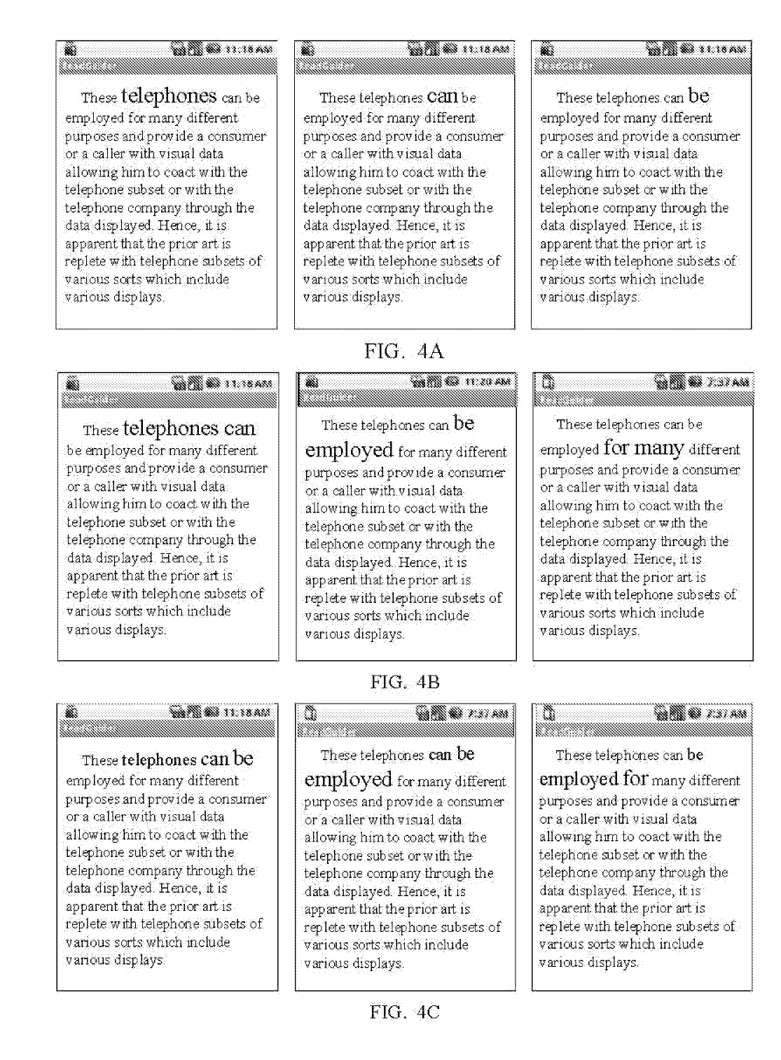

Referring to FIGS. 4A-4C, exemplary general views are shown that the fonts are changed to guide users to read the contents on the electronic device of FIG. 1. The font changing sub-module 131 changes in sequence the words displayed on the current interface in font size (shown in FIG. 4A). In another exemplary embodiment, the font changing sub-module 131 changes several words displayed in sequence in different font sizes each time (shown in FIGS. 4B and 4C). In still another exemplary embodiment, the font changing sub-module 131 can change the words font color, font style.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device, comprising:
a content display module to display contents of a file on an interface of the electronic device;
a storage to store a guidance list, wherein the guidance list defines a relationship between users and guidance behaviors relating to the users, the guidance behaviors comprising guide speeds and word changes corresponding to the users;
a reading control module comprising:
a font changing sub-module to search the guidance list to obtain the guide speed and the word changes corresponding to a particular user, and control fonts of words on a current page of the file to sequentially change according to the guide speed and the word changes; and;
a page flipping control sub-module to signal the content display module to flip to a next page when the current page is finished.

2. The electronic device as recited in claim 1, wherein the word changes comprises at least one type of change selected from the group consisting of change of font size, change of font color, and change of font style.

3. The electronic device as recited in claim 1, wherein the reading control module further comprises:
a guide speed calculating sub-module to calculate the guide speed, according to an elapsed time between two page flipping operations, and a volume of words displayed during the elapsed time.

4. The electronic device as recited in claim 3, wherein the reading control module updates the guiding list according to the guide speed calculated.

5. The electronic device as recited in claim 1, wherein the guidance behavior corresponding to a particular user is manually preset by the particular user.

6. A method for guiding reading applied in an electronic device, the method comprising:
a. displaying a guiding interface for a new user to register or for a registered user to login in and start a guide function, wherein a guidance list defines a relationship between the registered users and guidance behaviors relating to the registered users, the guidance behaviors comprising guide speeds and word changes corresponding to the registered users;
b. obtaining word changes and a guide speed corresponding to a particular registered user from the guidance list when the particular registered user is logged in and starts the guide function;
c. changing words of a current page in font pursuant to the guide speed and the word changes which are obtained from the guidance list;
d. determining whether the current page is finished according to the guide speed obtained and a volume of words on the current page; and
e. flipping to a next page according to a page flipping signal when the current page is finished.

7. The method as recited in claim 6, wherein steps c, d and e repeat till the guide function is terminated.

8. The method as recited in claim 6, wherein the word changes comprises at least one type of change selected from the group consisting of change of font size, change of font color, and change of font style.

9. The method as recited in claim 6, further comprising:
providing an operation interface for a new user to preset a guide speed and word changes;
receiving the preset guide speed and word changes via the operation interface;
storing the preset guide speed and word changes corresponding to the new user in the guidance list.

10. The method as recited in claim 9, wherein the operation interface allows the user to manually preset the guide speed.

11. The method as recited in claim 9, wherein the operation interface allows the user to start a test to preset the guide speed, the steps for the test of presetting the guide speed comprises:
monitoring an elapsed time between two page flipping operations;
determining a volume of words displayed during the elapsed time; and
calculating the guide speed according to the elapsed time and the volume of words.

12. The method as recited in claim 9, wherein the operation interface comprises one or more options for the user to preset word changes in font.
